(19) United States
(12) Patent Application Publication
(10) Pub. No.: US 2026/0260478 A1
(43) Pub. Date: Sep. 3, 2026

(54) MULTI-AGENT VISUAL PERCEPTION

(71) Applicant: ADOBE INC., SAN JOSE, CA (US)

(72) Inventors: Zhehao Zhang, Seattle, WA (US); Ryan A. Rossi, San Jose, CA (US); Tong Yu, Fremont, CA (US); Franck Dernoncourt, Seattle, WA (US); Ruiyi Zhang, Mountain View, CA (US); Jiuxiang Gu, Redmond, VA (US); Sungchul Kim, San Jose, CA (US); Xiang Chen, Palo Alto, CA (US); Zichao Wang, San Jose, CA (US); Nedim Lipka, Campbell, CA (US)

(21) Appl. No.: 19/066,517

(22) Filed: Feb. 28, 2025

(51) Int. Cl. G06V 10/70; G06F 16/3329; G06V 10/80

(52) U.S. Cl. CPC G06V 10/87; G06F 16/33295; G06V 10/809

(57) ABSTRACT

A method, apparatus, non-transitory computer readable medium, and system for answering queries about an image include obtaining an image and a query about the image. An image perception system then generates an action based on the image and the query using an orchestrator vision-language model. The image perception system then generates vision analysis result based the image and the action using a vision expert model. The image perception system then generates an answer to the query based on the vision analysis result.

### BACKGROUND

The following relates generally to image processing, and more specifically to image perception. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image perception refers to computational methods for understanding and deriving meaning from visual data. For example, machine learning (ML) techniques enable systems to perform tasks such as image classification, object detection, and image captioning. These techniques typically process pixel-level information to identify patterns, features, and semantic content within images. Recent developments have integrated vision encoders with language models, creating multimodal systems capable of processing and understanding both visual and textual information simultaneously.

### SUMMARY

Embodiments of the present inventive concepts include systems and methods for image perception. For example, embodiments are configured to answer a specific query about an image, such as a question about one or more locations in the image. An example image perception system includes an orchestrator model configured to generate a task requirement analysis to answer a query about an image. Embodiments of the orchestrator model include multimodal large language model (MLLM), such as a vision language model (VLM) configured to have non-task-specific understanding of images and text. The orchestrator model has access to one or more additional models, sometimes referred to as “agents”, that it can utilize to complete the tasks outlined in the task requirement analysis. In some examples, the orchestrator model has access to a plurality of specialized models configured to generate texts describing image, and a plurality of vision expert models configured to compute quantitative metrics on images, such as depth maps, segmentations, and similarity scores. The orchestrator agent uses these tools in an iterative manner to aggregate evidence about the image and then forms an answer to the query based on the evidence.

A method, apparatus, non-transitory computer readable medium, and system for image perception are described. One or more aspects of the method, apparatus, non-transitory computer readable medium, and system include obtaining an image and a query about the image; generating, using an orchestrator vision-language model, an action based on the image and the query; generating, using a vision expert model, a vision analysis result based the image and the action; and generating, using the orchestrator vision-language model, an answer to the query based on the vision analysis result.

A method, apparatus, non-transitory computer readable medium, and system for image perception are described. One or more aspects of the method, apparatus, non-transitory computer readable medium, and system include obtaining an image and a query about the image; generating, using an orchestrator vision-language model, an action based on the image and the query; generating, using a specialized vision-language model, an analysis result based the image and the action; and generating, using the orchestrator vision-language model, an answer to the query based on the analysis result.

An apparatus, system, and method for image perception are described. One or more aspects of the apparatus, system, and method include a memory component; a processing device coupled to the memory component, the processing device configured to perform operations comprising: obtaining an image and a query about the image; generating, using an orchestrator vision-language model, an action based on the image and the query; generating, using a vision expert model, a vision analysis result based the image and the action; and generating, using the orchestrator vision-language model, an answer to the query based on the vision analysis result.

### BRIEF DESCRIPTION OF THE DRAWINGS

FIG. 1 shows an example of an image perception system according to aspects of the present disclosure.

FIG. 2 shows an example of an image perception apparatus according to aspects of the present disclosure.

FIG. 3 shows an example of a transformer architecture according to aspects of the present disclosure.

FIG. 4 shows an example of an operation of the orchestrator model according to aspects of the present disclosure.

FIGS. 5A-5C show examples of specialized models according to aspects of the present disclosure.

FIGS. 6A-6C show examples of vision expert models according to aspects of the present disclosure.

FIG. 7 shows an example of an image perception pipeline according to aspects of the present disclosure.

FIG. 8 shows an example of an algorithm for obtaining a response to a query about an image according to aspects of the present disclosure.

FIG. 9 shows an example of a method for generating a response to a query about an image according to aspects of the present disclosure.

FIG. 10 shows an example of step-by-step algorithm for training an ML model according to aspects of the present disclosure.

FIG. 11 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Image perception is one application of image processing that is focused on computationally understanding and extracting semantic meaning from visual data. This includes tasks such as object detection, scene understanding, and image captioning. Machine learning techniques have advanced this technology and enabled systems to classify images, detect objects, and generate descriptive text.

Image perception has applications across industries—from analyzing medical imaging data to detect abnormalities, to enabling autonomous vehicles to recognize road signs and obstacles, to powering quality control systems in manufacturing for defect detection. Recent developments have focused on Large Language Models (LLMs) and their multimodal variants (MLLMs), which combine natural language processing capabilities with visual understanding. These models can process both text and images simultaneously, leading to more sophisticated visual reasoning capabilities. Vision Language Models (VLMs) are a specific class of MLLMs configured to process visual and text information.

Conventional approaches to using VLMs for image perception involve inputting the image and a query to the VLM and relying on the capabilities of the single model to answer the query. While VLMs like BLIP have demonstrated success in general image understanding tasks, they often struggle with fine-grained visual perception. These limitations become particularly apparent when the models are asked to analyze specific regions of an image or make precise comparisons between multiple images. Additionally, single-model approaches tend to produce inconsistent or incorrect responses (often termed “hallucinations”) when dealing with complex queries that require detailed visual analysis.

Recent developments have explored integrating VLMs with additional tools and models to enhance their capabilities. However, these approaches typically process only the query text through the language model component, and do not fully utilize the visual information during the planning and reasoning stages. For example, the VLM is typically used to generate a base caption, and then an LLM must rely on this sparse information to answer the query. This limitation restricts their effectiveness to relatively simple scenarios and impacts their ability to handle tasks requiring detailed visual perception or analysis across multiple images.

Embodiments of the present disclosure greatly improve the accuracy of image perception through the use of multiple agents. The system employs an orchestrator model that first generates a task requirement analysis, breaking down the steps needed to answer a query about an image. The orchestrator agent then leverages specialized models and vision expert models to obtain detailed information for executing these tasks. Throughout this process, the orchestrator agent accumulates supporting evidence, which is incorporated into the generated answer to minimize incorrect responses and provide traceable reasoning paths.

The present embodiments offer significant advantages for visual perception applications where accuracy and reliability are paramount. In medical imaging, for instance, the system's ability to provide detailed evidence for its analysis helps healthcare professionals make more informed decisions about diagnostic findings. The extensible system's reduced likelihood of incorrect responses is particularly valuable in autonomous vehicle systems, where precise object detection and distance estimation directly impact safety. The multi-agent architecture also enables more efficient resource utilization compared to monolithic systems, as specialized models can be selectively employed based on task requirements. Furthermore, the iterative evidence aggregation process creates an audit trail of decision-making that is especially valuable in applications like manufacturing quality control and security surveillance, where system decisions must be verifiable and traceable. This improved traceability and reliability represents a significant advancement in visual perception technology.

The present disclosure describes several examples of specialized models and vision expert models that may be utilized by the orchestrator model. However, it will be appreciated that the framework is flexible and extensible, allowing for integration of additional or alternative models—including those yet to be developed—while maintaining the core orchestration functionality.

As used herein, an “orchestrator model” refers to a vision language model configured to process an input query and image, and to generate a plan to answer the query. The plan may include an action. An “action” is a sub-task that is to be directed to a specialized model or a vision expert. A specialized model may be, for example, another vision language model that is fine-tuned for a specific task such as generating a descriptive caption of a sub-region of the image. A vision expert is a component (e.g., a rule-based or ML-based model) configured to quantify some aspect of its inputs. Example of vision expert models include depth-estimation models, image segmentation models, and image comparison models.

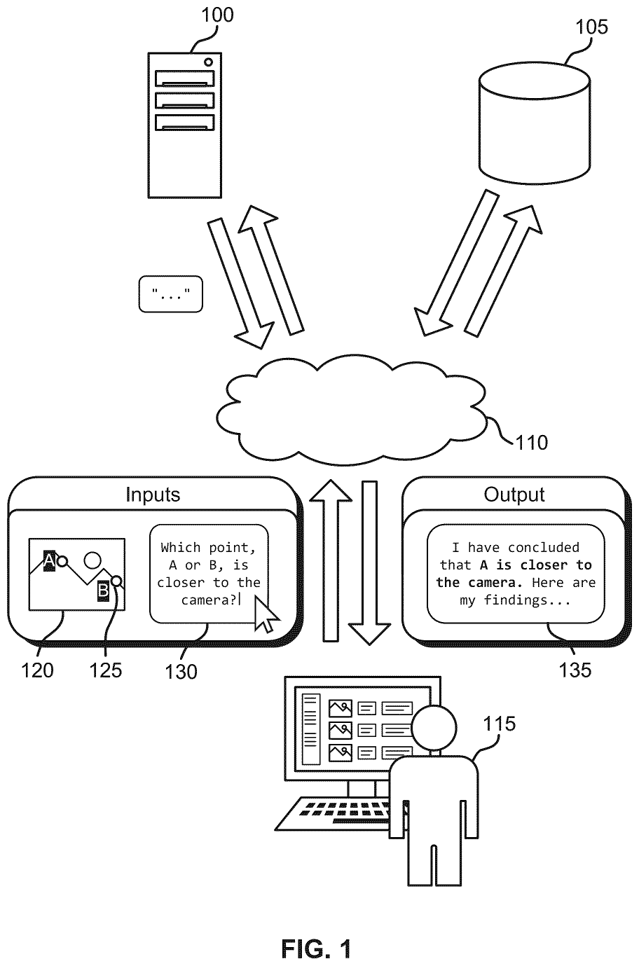

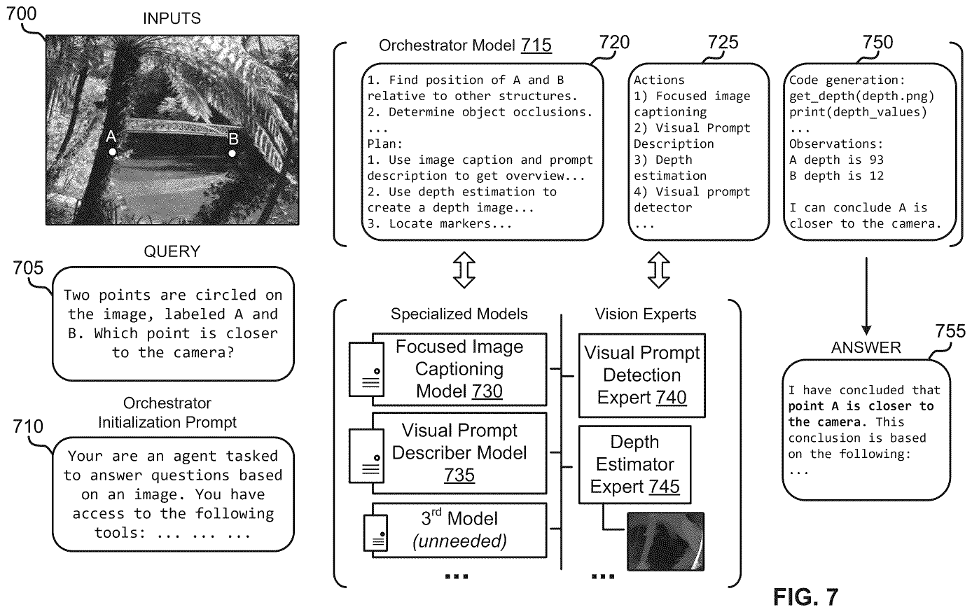

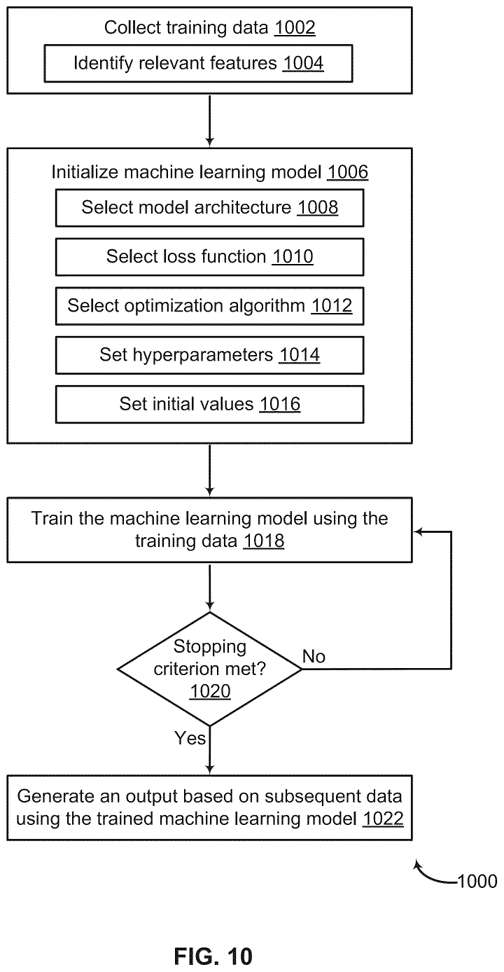

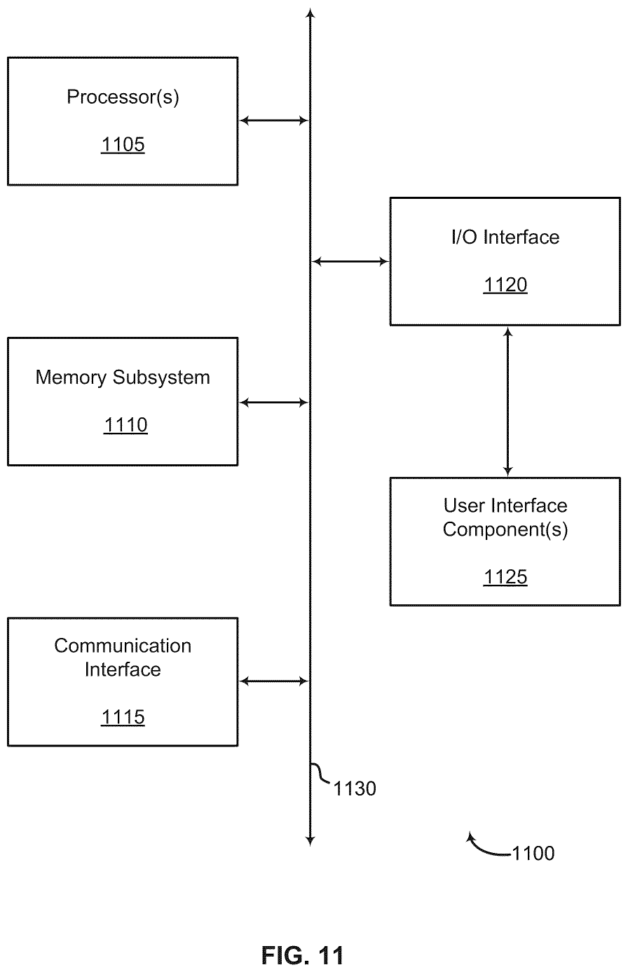

An image perception system is described with reference to FIGS. 1-6C. Methods and pipelines for generating answers to a query about an image are described with reference to FIGS. 7-9. A training algorithm for training or finetuning an ML model is described with reference to FIG. 10. A computing device configured to implement an image perception apparatus is described with reference to FIG. 11.

### Image Perception System

FIG. 1 shows an example of an image perception system according to aspects of the present disclosure. The example shown includes image perception apparatus 100, database 105, network 110, user 115, input image 120, (optional) image annotation 125, query 130, and response 135.

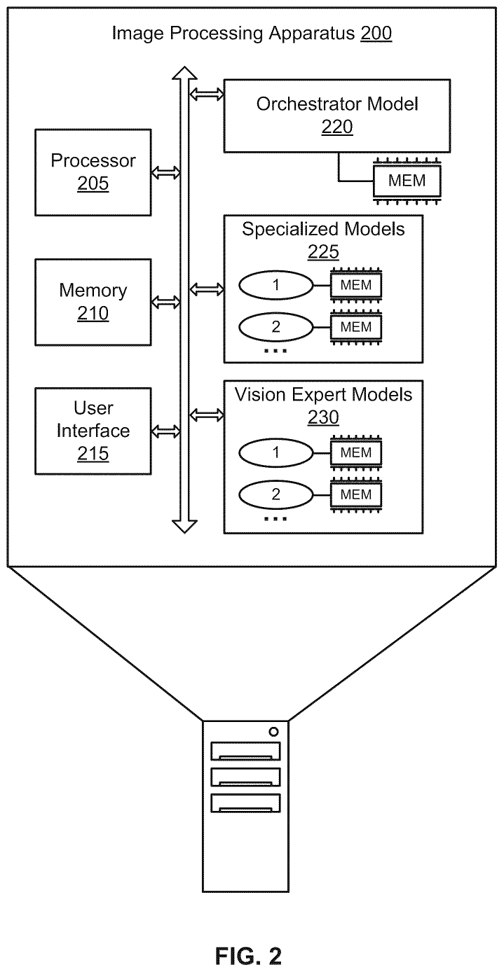

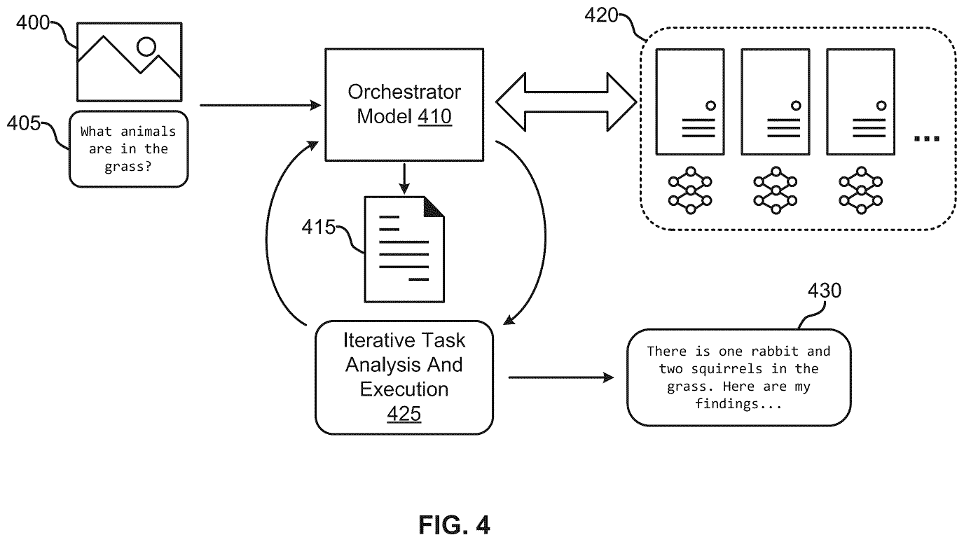

Image perception apparatus 100 is an example of, or includes aspects of, the corresponding element described with reference to FIG. 2. Input image 120 is an example of, or includes aspects of, the corresponding element described with reference to FIGS. 4-6. Query 130 is an example of, or includes aspects of, the corresponding element described with reference to FIGS. 4 and 7.

In an example process, user 115 provides input image 120 and query 130 to the system via a user interface. The query 130 may be a question about the input image 120. The input image 120 may have an image annotation 125, which identifies a position on the image. Then, image perception apparatus 100 processes the inputs using an iterative solving method with multiple agents, formulating a response to the question. The response 135 may include an answer to query 130, as well as additional reasoning as to why the system came to this conclusion. For example, the image perception apparatus 100 may include its chain of thought and any evidence gathered in answering query 130 in response 135.

In some embodiments, one or more components of image perception apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the image perception system. For example, database 105 may store model parameters, generated texts, generated images, generated videos, user configuration settings, activity history, model training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

A database 105 is an organized collection of data. For example, a database 105 stores data in a specified format known as a schema. A database 105 may be structured as a single database 105, a distributed database 105, multiple distributed databases 105, or an emergency backup database 105. In some cases, a database 105 controller may manage data storage and processing in a database 105. In some cases, a user 115 interacts with database 105 controller. In other cases, database 105 controller may operate automatically without user 115 interaction.

Network 110 facilitates the transfer of information between image perception apparatus 100, database 105, and user 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image perception apparatus 200 according to aspects of the present disclosure. The example shown includes image perception apparatus 200, processor 205, memory 210, user interface 215, orchestrator model 220, specialized models 225, and vision expert models 230.

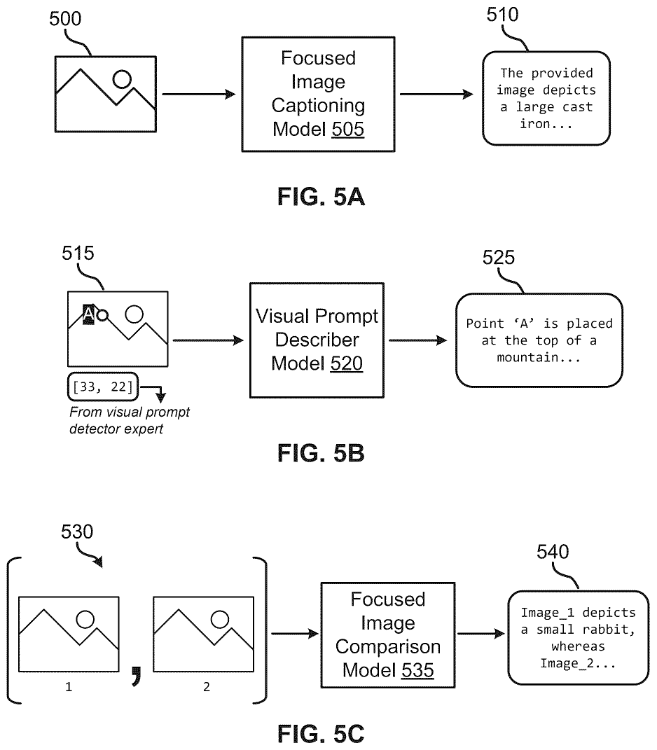

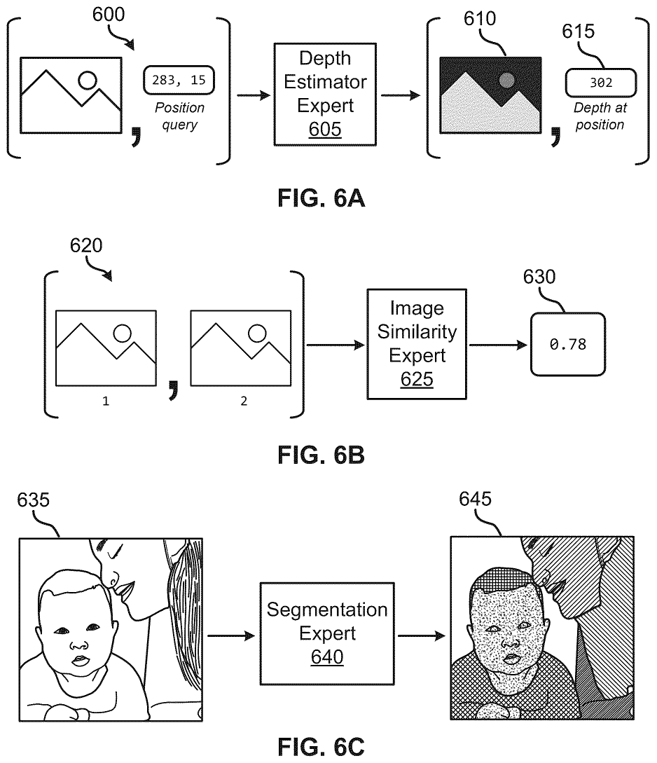

Image perception apparatus 200 is an example of, or includes aspects of, the corresponding element described with reference to FIG. 1. Orchestrator model 220 is an example of, or includes aspects of, the corresponding element described with reference to FIGS. 4 and 7. Additional examples of specialized models 225 are described with reference to FIGS. 5A-5C. Additional examples of vision expert models 230 are described with reference to FIGS. 6A-6C.

A processor 205 is an intelligent hardware device, (e.g., a general-purpose processing component, a digital signal processor 205 (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). The processor 205 may be configured to perform millions or billions of tensor operations per second, enabling real-time processing of complex visual data through parallel computation paths. In some cases, the processor 205 is configured to operate a memory 210 array using a memory controller. In other cases, a memory controller is integrated into the processor 205. In some cases, the processor 205 is configured to execute computer-readable instructions stored in a memory 210 to perform various functions. In some embodiments, a processor 205 includes special purpose components for visual data processing, neural network acceleration, or multi-agent coordination.

Examples of a memory 210 device include random access memory 210 (RAM), read-only memory 210 (ROM), or a hard disk. Examples of memory 210 devices include solid state memory 210 and a hard disk drive. In some examples, memory 210 is used to store computer-readable, computer-executable software including instructions that, when executed, cause a processor 205 to perform various functions described herein. In some cases, the memory 210 contains, among other things, a basic input/output system (BIOS) which controls basic hardware or software operation such as the interaction with peripheral components or devices. In some cases, a memory 210 controller operates memory 210 cells. For example, the memory 210 controller can include a row decoder, column decoder, or both. In some cases, memory 210 cells within a memory 210 store information in the form of a logical state.

Each component of the system may include dedicated hardware resources. For example, the orchestrator model 220, specialized models 225, and vision expert models 230 may each have their own dedicated memory devices, labeled ‘MEM’ in FIG. 2, storing model parameters, weights, and configurations specific to their respective functions. These dedicated memory devices may be optimized for the specific processing requirements of each model, such as high-bandwidth memory for vision processing or low-latency memory for orchestrator operations. The dedicated hardware architecture enables parallel processing across multiple agents while minimizing memory access bottlenecks.

The system may employ specialized hardware configurations to optimize performance. For example, vision expert models 230 may utilize dedicated neural processing units (NPUs) or tensor processing units (TPUs) for efficient execution of computer vision operations. The orchestrator model 220 may leverage specialized scheduling hardware to manage real-time coordination between multiple agents. Inter-agent communication may be facilitated through dedicated high-speed interconnects, enabling efficient data transfer between components. The system may also include hardware-level synchronization mechanisms to ensure coherent operation across multiple processing units working in parallel.

A user interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, user interface 215 includes a graphical user interface (GUI).

The components of image processing apparatus 200, such as orchestrator model 220, specialized models 225, or vision expert models 230, may utilize a “transformer.” A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

In language models, the transformer architecture enables processing of variable-length text sequences through self-attention mechanisms. The model processes input text by converting words or subwords into embeddings and applying multiple layers of self-attention and feed-forward neural networks. Each layer allows the model to learn increasingly complex relationships between words in the input sequence. The self-attention mechanism enables the model to weigh the importance of different words in the context when predicting the next word or performing other language tasks. This architecture can be scaled to handle large amounts of text data by increasing the number of parameters, layers, and attention heads, leading to improved performance on various natural language processing tasks such as text generation, translation, and comprehension.

Multimodal large language models (MLLMs) extend the transformer architecture to process both text and other modalities such as images or audio. One implementation approach involves using separate encoders for different modalities, such as a vision encoder for processing images and a language model for processing text. The vision encoder converts visual information into a dense vector representation in the same dimensional space as the text embeddings. A modality interface or connector then aligns these representations with the language model's embedding space, allowing the model to process both modalities coherently. The language model can then generate text outputs based on both the visual and textual inputs it receives. This architecture enables the model to perform tasks that require understanding and generating text based on multiple types of input, such as answering questions about images or generating descriptions of visual content.

Orchestrator model is a multimodal language model (MLLM) configured to process an input text and query, and to generate a task requirement analysis including at least one action therefrom. According to some aspects, orchestrator model 220 generates an answer to the query based on a vision analysis result generated by one or more of vision expert models 230 or an analysis result generated by one or more of specialized models 225. In some examples, orchestrator model 220 generates a subsequent action based on a vision analysis result or the analysis result. In some examples, orchestrator model 220 selects the vision expert model from a set of vision expert models 230 or the specialized model from a set of specialized models 225 based on the action.

Specialized models 225 include LLMs and MLLMs trained for specific perception tasks. Examples of specialized models 225 include a focused image captioning model, a visual prompt describer model, and a focused image comparison model. Additional detail regarding these examples is provided with reference to FIGS. 5A-5C.

Components of the system, particularly the vision expert models 230, may utilize a CNN for image processing. A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Vision expert models 230 include components that are configured to process an image to extract information therefrom without necessarily generating text. Examples of vision expert models 230 include components for: detecting visual prompts (e.g., labeled points or lines on an image), estimating the depth of objects within an image, detecting objects within an image and generating bounding boxes for the object, segmenting the image into regions to obtain spatial relationships, and comparing two images to generate a similarity score. Additional detail regarding examples of vision expert models 230 is provided with reference to FIGS. 6A-6C.

In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics.

Depth estimation refers to techniques for determining the distance between the camera and various points in a scene from one or more images. Traditional rule-based approaches to depth estimation include stereo matching, which compares images from two cameras to find corresponding points and calculate disparity, and structure from motion, which estimates depth from multiple views of a scene captured by a moving camera. These approaches typically rely on geometric principles such as triangulation and epipolar geometry. Single-image depth estimation can be performed using various cues such as texture gradients, perspective effects, relative size of known objects, and atmospheric effects.

Machine learning approaches to depth estimation include supervised learning methods where models are trained on image-depth pairs, often collected using specialized depth sensors or structured light systems. Neural network architectures for depth estimation commonly employ encoder-decoder structures to process the input image at multiple scales and generate dense depth maps. These models can learn to leverage both low-level image features such as edges and textures, as well as high-level semantic understanding of scene composition and object relationships to predict depth values. The predicted depth maps can be represented as either relative depth ordering between pixels or absolute depth values in metric units, depending on the training data and intended application.

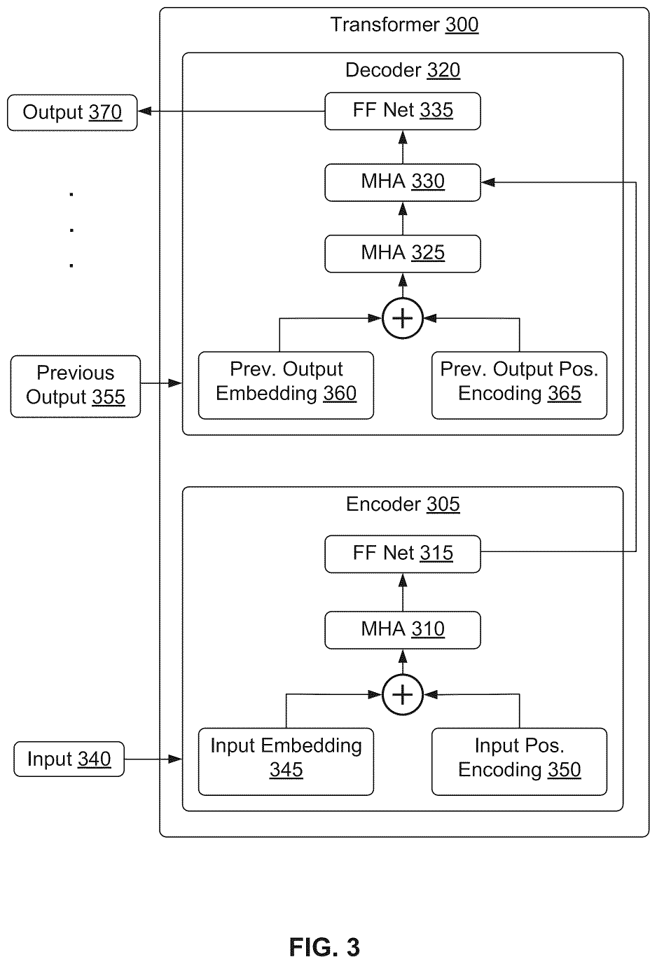

FIG. 3 shows an example of a transformer network according to aspects of the present disclosure. The example shown includes transformer 300, encoder 305, decoder 320, input 340, input embedding 345, input positional encoding 350, previous output 355, previous output embedding 360, previous output positional encoding 365, and output 370.

In some cases, encoder 305 includes multi-head self-attention sublayer 310 and feed-forward network sublayer 315. In some cases, decoder 320 includes first multi-head self-attention sublayer 325, second multi-head self-attention sublayer 330, and feed-forward network sublayer 335.

According to some aspects, a machine learning model (such as the orchestrator model and the specialized models described with reference to FIG. 2) comprises transformer 300. In some cases, encoder 305 is configured to map input 340 (for example, a query or a prompt comprising a sequence of words or tokens) to a sequence of continuous representations that are fed into decoder 320. In some cases, decoder 320 generates output 370 (e.g., a prediction of an output sequence of words or tokens) based on the output of encoder 305 and previous output 355 (e.g., a previously predicted output sequence), which allows for the use of autoregression.

For example, in some cases, encoder 305 parses input 340 into tokens and vectorizes the parsed tokens to obtain input embedding 345, and adds input positional encoding 350 (e.g., positional encoding vectors for input 340 of a same dimension as input embedding 345) to input embedding 345. In some cases, input positional encoding 350 includes information about relative positions of words or tokens in input 340.

In some cases, encoder 305 comprises one or more encoding layers (e.g., six encoding layers) that generate contextualized token representations, where each representation corresponds to a token that combines information from other input tokens via self-attention mechanism. In some cases, each encoding layer of encoder 305 comprises a multi-head self-attention sublayer (e.g., multi-head self-attention sublayer 310). In some cases, the multi-head self-attention sublayer implements a multi-head self-attention mechanism that receives different linearly projected versions of queries, keys, and values to produce outputs in parallel. In some cases, each encoding layer of encoder 305 also includes a fully connected feed-forward network sublayer (e.g., feed-forward network sublayer 315) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation to each word or token in input 340. As described with reference to FIG. 2, a multimodal encoder may generate tokens interpretable by the transformer from data of different modalities, such as image data, sound data, and video data. A connector network may project these tokens into the same embedding space as other modalities, e.g., the tokens representing text.

In some cases, each sublayer of encoder 305 is followed by a normalization layer that normalizes a sum computed between a sublayer input x and an output sublayer (x) generated by the sublayer:

$$layernorm ( x + sublayer ( x ) ) \qquad ( 2 )$$

In some cases, encoder 305 is bidirectional because encoder 305 attends to each word or token in input 340 regardless of a position of the word or token in input 340.

In some cases, decoder 320 comprises one or more decoding layers (e.g., six decoding layers). In some cases, each decoding layer comprises three sublayers including a first multi-head self-attention sublayer (e.g., first multi-head self-attention sublayer 325), a second multi-head self-attention sublayer (e.g., second multi-head self-attention sublayer 330), and a feed-forward network sublayer (e.g., feed-forward network sublayer 335). In some cases, each sublayer of decoder 320 is followed by a normalization layer that normalizes a sum computed between a sublayer input x and an output sublayer (x) generated by the sublayer.

In some cases, decoder 320 generates previous output embedding 360 of previous output 355 and adds previous output positional encoding 365 (e.g., position information for words or tokens in previous output 355) to previous output embedding 360. In some cases, each first multi-head self-attention sublayer receives the combination of previous output embedding 360 and previous output positional encoding 365 and applies a multi-head self-attention mechanism to the combination. In some cases, for each word in an input sequence, each first multi-head self-attention sublayer of decoder 320 attends only to words preceding the word in the sequence, and so transformer 300's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 305 by receiving a query Q from a previous sublayer of decoder 320 and a key K and a value V from the output of encoder 305, allowing decoder 320 to attend to each word in the input 340.

In some cases, each feed-forward network sublayer implements a fully connected feed-forward network similar to feed-forward network sublayer 315. In some cases, the feed-forward network sublayers are followed by a linear transformation and a softmax function to generate a prediction of output 370 (e.g., a prediction of a next word or token in a sequence of words or tokens). According to some aspects, this prediction of a next word or token is generated in the form of a probability distribution over a token vocabulary, and this probability distribution is used utilized directly by embodiments herein as the “classification result” of a decision node.

FIG. 4 shows an example of an operation of the orchestrator model 410 according to aspects of the present disclosure. The example shown includes input image 400, query 405, orchestrator model 410, task requirement analysis 415, external agent(s) 420, iterative task analysis and execution 425, and response to query 430.

Input image 400 is an example of, or includes aspects of, the corresponding element described with reference to FIGS. 1, 5, and 6. Query 405 is an example of, or includes aspects of, the corresponding element described with reference to FIGS. 1 and 7. Orchestrator model 410 is an example of, or includes aspects of, the corresponding element described with reference to FIGS. 2 and 7. Task requirement analysis 415 is an example of, or includes aspects of, the corresponding element described with reference to FIG. 7. Response to query 430 is an example of, or includes aspects of, the corresponding element described with reference to FIGS. 1 and 7.

In this example, the orchestrator model 410 processes input image 400 and query 405 to generate response to query 430. First, the orchestrator model 410 generates a task requirement analysis 415, which includes a set of actions the system will perform to obtain relevant data to support answering the query. The actions may be mapped to the abilities of external agent(s) 420. For example, the orchestrator model 410 may be conditioned (e.g., through an initial prompt, retrieval augmented generation (RAG), or a finetuning phase) to understand a set of available tools. These tools may be, for example, accessed via functions that call on application programming interfaces (APIs) of other models, such as those described with reference to FIG. 2. The orchestrator model 410 may provide information to the external agent(s) 420 as applicable, such as the input image 400 and query 405.

The orchestrator model 410 may then reference the generated task requirement analysis 415, and execute code that calls the functionality of external agent(s) 420 based on the set of actions. In some cases, the results from external agent(s) 420 will raise additional questions, in which case orchestrator model 410 may update the task requirement analysis 415 with additional actions. For example, the external agent(s) 420 may return answers or additional images or other data that are processed by orchestrator model 410 that necessitate additional actions to resolve unknowns. Accordingly, orchestrator model 410 will perform iterative task analysis and execution 425 until, for example, a threshold number of iterations has been reached or a predefined confidence level in the accuracy of response to query 430 is reached. In this way, the orchestrator model 410 of the present disclosure generates an interpretable, traceable answer to an input query with minimal hallucinations.

FIGS. 5A-5C show examples of specialized models according to aspects of the present disclosure. The example shown includes input image 500, focused image captioning model 505, descriptive caption 510, input annotated image 515, visual prompt describer model 520, description with focus on annotated portions 525, input images 530, focused image comparison model 535, and descriptive comparison 540.

Input image 500 is an example of, or includes aspects of, the corresponding element described with reference to FIGS. 1, 4, and 6. Focused image captioning model 505 is an example of, or includes aspects of, the corresponding element described with reference to FIG. 7. Input annotated image 515 is an example of, or includes aspects of, the corresponding element described with reference to FIG. 7. Visual prompt describer model 520 is an example of, or includes aspects of, the corresponding element described with reference to FIG. 7. Input images 530 is an example of, or includes aspects of, the corresponding element described with reference to FIGS. 6A-6C.

FIG. 5A illustrates the operation of a focused image captioning model 505. The focused image captioning model 505 processes input image 500 to generate descriptive caption 510. The focused image captioning model 505 may be implemented using transformer architecture as described with reference to FIG. 2, with dedicated memory modules storing task-specific parameters for image captioning. The model generates detailed descriptions of the image content in input image 500. Embodiments of the focused image captioning model 505 include a “focus” parameter that controls a level of detail in the generated caption about a specified object or objects in the image.

FIG. 5B illustrates the operation of a visual prompt describer model 520. The visual prompt describer model 520 processes input annotated image 515 to generate description with focus on annotated portions 525. Like the focused image captioning model 505, the visual prompt describer model 520 may be implemented using transformer architecture with dedicated memory modules storing specialized parameters. This model is configured to analyze and describe visual annotations within images, such as highlighted regions, arrows, or bounding boxes, providing detailed descriptions of both the annotations themselves and the image content they reference.

FIG. 5C illustrates the operation of a focused image comparison model 535. The focused image comparison model 535 processes multiple input images 530 to generate descriptive comparison 540. The model may be implemented using transformer architecture with dedicated memory modules storing parameters specific to comparative analysis. The focused image comparison model 535 analyzes multiple images to identify and describe similarities and differences, with capability to focus on specific elements or features as needed for the task.

While the above describes only three examples of specialized models, it will be appreciated that additional specialized models may be utilized. Each of these specialized models enhances the system's ability to perform detailed visual analysis by breaking down complex perception tasks into specific sub-tasks. The models work in conjunction with the orchestrator model described with reference to FIG. 4, which can selectively utilize their capabilities based on task requirements. This modular architecture enables precise and traceable visual analysis across a variety of applications.

FIGS. 6A-6C show examples of vision expert models according to aspects of the present disclosure. The example shown includes input image and position 600, depth estimator expert 605, depth image 610, depth estimation at position 615, input images 620, image similarity expert 625, similarity score 630, input image 635, segmentation expert 640, and segmented image 645.

Depth estimator expert 605 is an example of, or includes aspects of, the corresponding element described with reference to FIG. 7. Input images 620 is an example of, or includes aspects of, the corresponding element described with reference to FIGS. 5A-5C. Input image 635 is an example of, or includes aspects of, the corresponding element described with reference to FIGS. 1, 4, and 5.

FIG. 6A illustrates the operation of a depth estimator expert 605. The depth estimator expert 605 processes input image and position 600 to generate depth image 610 and depth estimation at position 615. The depth image 610 represents the relative distances of objects from the camera in a grayscale format. The depth estimation at position 615 provides a specific depth value at a pixel position of interest. In some embodiments, the pixel position is determined by a separate vision prompt detector model. In other embodiments, the vision prompt detection functionality is integrated within the depth estimator expert 605. The depth estimator expert 605 may be implemented using specialized computer vision models with dedicated memory modules storing parameters trained for depth estimation tasks.

FIG. 6B illustrates the operation of an image similarity expert 625. The image similarity expert 625 processes input images 620 to generate similarity score 630. The model generates compact representations of visual content and computes similarity metrics, such as cosine similarity, between these representations. The image similarity expert 625 may be implemented using neural network architectures specialized for embedding generation, with dedicated memory modules storing parameters trained for similarity computation tasks. The image similarity expert may then 625 directly compare the embeddings using known techniques to generate similarity score 630.

FIG. 6C illustrates the operation of a segmentation expert 640. The segmentation expert 640 processes input image 635 to generate segmented image 645. The model combines object detection and image segmentation capabilities, identifying and localizing objects while also providing precise delineation of object boundaries. The segmented image 645 includes both bounding boxes around detected objects and detailed segmentation masks. The segmentation expert 640 may be implemented using specialized computer vision architectures with dedicated memory modules storing parameters trained for both object detection and segmentation tasks.

While the above describes only three examples of specialized models, it will be appreciated that additional vision expert models may be utilized. These vision expert models provide quantitative metrics and processed images that can be utilized by the orchestrator model described with reference to FIG. 4. The combination of numerical outputs and processed images enables detailed analysis of spatial relationships, object characteristics, and visual similarities, thereby enhancing the system's ability to perform accurate visual perception tasks.

### Methods for Perceiving Images

FIG. 7 shows an example of an image perception pipeline according to aspects of the present disclosure. The example shown includes input annotated image 700, query 705, optional initialization prompt 710, orchestrator model 715, task requirement analysis 720, actions 725, focused image captioning model 730, visual prompt describer model 735, visual prompt detection expert 740, depth estimator expert 745, evidence for response 750, and response to query 755.

Input annotated image 700 is an example of, or includes aspects of, the corresponding element described with reference to FIGS. 5A-5C. Query 705 is an example of, or includes aspects of, the corresponding element described with reference to FIGS. 1 and 4. Orchestrator model 715 is an example of, or includes aspects of, the corresponding element described with reference to FIGS. 2 and 4. Task requirement analysis 720 is an example of, or includes aspects of, the corresponding element described with reference to FIG. 4. Focused image captioning model 730 is an example of, or includes aspects of, the corresponding element described with reference to FIGS. 5A-5C. Visual prompt describer model 735 is an example of, or includes aspects of, the corresponding element described with reference to FIG. FIGS. 5A-5C. Depth estimator expert 745 is an example of, or includes aspects of, the corresponding element described with reference to FIGS. 6A-6C. Response to query 755 is an example of, or includes aspects of, the corresponding element described with reference to FIGS. 1 and 4.

The example shown in FIG. 7 shows how an image perception system according to the present disclosure might solve a query about an image. In this example, a user or external system provides inputs including input annotated image 700 and query 705. The query asks the system about two points on the image, A, and B, and specifically which point is closer to the camera. In some embodiments, the system is initialized with optional initialization prompt 710, which indicates to the orchestrator model 715 which additional tools are available to it. For example, the optional initialization prompt 710 may instruct the orchestrator model 715 to generate a task requirement analysis that includes actions, and indicate which specialized models and vision experts are available to address the actions (as well as the abilities of the orchestrator model 715 itself).

The orchestrator model 715 first prepares task requirement analysis 720, which lays out the plan for answering query 705 and includes actions 725. When applicable to actions 725, the orchestrator model calls upon the functionalities of relevant specialized models and/or vision experts. For this particular query, the orchestrator model 715 has determined that the focused image captioning model 730, the visual prompt describer model 735, the visual prompt detection expert 740, and the depth estimator expert 745 will be useful.

In this example, orchestrator model 715 obtains the coordinates of points A and B using the visual prompt detection expert 740, which returns the pixel locations of annotations in an input image. Then, orchestrator model 715 gathers additional information about the layout of the image using focused image captioning model 730. The orchestrator model 715 then gets detailed information about the visual information near points A and B. The orchestrator model 715 has further determined that, to answer a query related to distance to a camera, depth estimator expert 745 is needed. The depth estimator expert 745 may generate a depth image that represents the estimated depths of every point in input annotated image 700. Then, using the extracted pixel locations of points A and B, the orchestrator model 715 obtains the corresponding depth values of A and B. These steps are aggregated in a state referred to as evidence for response 750, and the evidence for response 750 is used by orchestrator model 715 to generate response to query 755.

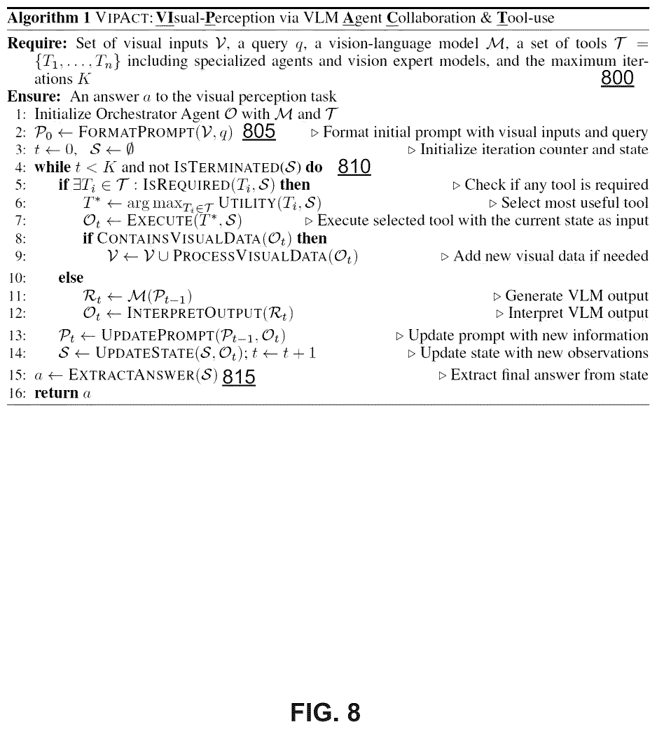

FIG. 8 shows an example of an algorithm for obtaining a response to a query about an image according to aspects of the present disclosure. The example shown includes inputs 800, initialization steps 805, image perception loop 810, and extract query answer from evidence state 815.

The inputs 800 include one or more input images, a query about the image(s), and a set of available tools including specialized models (as described with reference to FIGS. 5A-5C) and vision expert models (as described with reference to FIGS. 6A-6C). The inputs 800 may also specify a maximum number of iterations for processing.

The initialization steps 805 include initializing an orchestrator model (as described with reference to FIG. 4) and formatting an initial prompt based on the input images and query. For example, the initial prompt may be based on a template prompt provided to the orchestrator model and filled in with details from the input images and query. The orchestrator model and other models may be implemented using the hardware architecture described with reference to FIG. 2, including dedicated memory modules for storing model parameters.

The image perception loop 810 represents an iterative process where the orchestrator model determines whether to utilize additional tools to gather evidence for answering the query. When a tool is required, the orchestrator model selects the most useful tool from the available set and executes it. The tool may return visual data (e.g., processed images from vision expert models) or textual data (e.g., descriptions from specialized models), which is incorporated into the current state. The orchestrator model updates its internal prompt with the new information and continues this process until either the maximum number of iterations is reached or sufficient evidence has been gathered.

The extract query answer from evidence state 815 represents the final step where the orchestrator model processes all gathered evidence to generate a response to the input query. This response is based on the accumulated evidence from multiple specialized models and vision expert models and provides a traceable path of reasoning from the input query to the final answer.

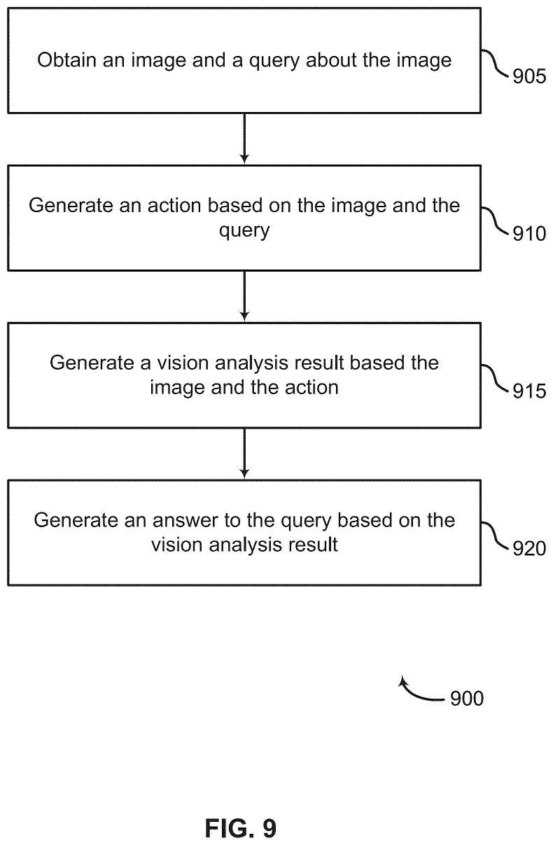

FIG. 9 shows an example of a method 900 for generating a response to a query about an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains an image and a query about the image. In some cases, the operations of this step refer to, or may be performed by, an image perception apparatus as described with reference to FIGS. 1 and 2. The image and query may be provided by a user or may be provided by some external system such as an autonomous robot or vehicle. The query may include a natural language question about specific aspects or regions of the image.

At operation 910, the system generates an action based on the image and the query. In some cases, the operations of this step refer to, or may be performed by, an orchestrator vision-language (VLM) model as described with reference to FIGS. 2, 4, and 7. The orchestrator vision-language model analyzes the query requirements and determines what specific visual analysis tasks need to be performed. The action may include, for example, a request to analyze depth information at a specific location, compare similarities between image regions, or generate detailed descriptions of particular image areas. The orchestrator vision-language model may map the action to an additional model configured to perform that action, such as a specialized model or vision expert model.

At operation 915, the system generates a vision analysis result based the image and the action. In some cases, the operations of this step refer to, or may be performed by, a vision expert model as described with reference to FIGS. 2 and 6A-6C. A vision analysis result may include, but is not limited to, depth measurements, similarity scores between image regions, segmentation masks identifying object boundaries, or detection results indicating object locations. The vision analysis result provides quantitative or structured data about specific aspects of the image as requested by the action.

At operation 920, the system generates an answer to the query based on the vision analysis result. In some cases, the operations of this step refer to, or may be performed by, an orchestrator model as described with reference to FIGS. 2, 4, and 7. The orchestrator model processes the vision analysis result to formulate a natural language response that directly addresses the original query. The answer may incorporate evidence from one or more vision analysis results to provide a detailed and accurate response. In some cases, if the vision analysis result suggests the need for additional analysis, the system may return to operation 910 to generate additional actions before formulating the final answer.

FIG. 10 is a flow diagram depicting an algorithm as a step-by-step procedure 1000 in an example implementation of operations performable for training a machine-learning model. In some embodiments, the procedure 1000 describes operations applicable to training, e.g., specialized models and vision experts as described with reference to FIG. 2. The procedure 1800 provides one or more examples of generating training data, use of the training data to train a machine-learning model, and use of the trained machine-learning model to perform a task. In some cases, the training operations may be applied to a pre-trained “foundation model” to specialize the model to excel at a more specific task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1010) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained is configured to perform that task based on subsequent data received as an input and processed by the machine-learning model.

FIG. 11 shows an example of a computing device 1100 according to aspects of the present disclosure. The example shown includes computing device 1100, processor(s) 1105, memory subsystem 1110, communication interface 1115, I/O interface 1120, user interface component(s), and channel 1130.

In some embodiments, computing device 1100 is an example of, or includes aspects of, an image perception apparatus as described in FIGS. 1 and 2. In some embodiments, computing device 1100 includes one or more processors 1105 are configured to execute instructions stored in memory subsystem 1110 to obtain an image and a query about the image; generate, using an orchestrator vision-language model, an action based on the image and the query; generate, using a vision expert model, a vision analysis result based the image and the action; and generate, using the orchestrator vision-language model, an answer to the query based on the vision analysis result.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

Accordingly, the present disclosure includes the following aspects.

A method for image perception is described. One or more aspects of the method include obtaining an image and a query about the image; generating, using an orchestrator vision-language model, an action based on the image and the query; generating, using a vision expert model, a vision analysis result based the image and the action; and generating, using the orchestrator vision-language model, an answer to the query based on the vision analysis result.

Some examples of the method, apparatus, non-transitory computer readable medium, and system further include generating, using a specialized vision-language model, a prompt for the vision expert model, wherein the vision analysis result is based on the prompt. Some examples of the method, apparatus, non-transitory computer readable medium, and system further include generating a task requirement analysis comprising a plurality of actions including the action. In some aspects, the vision analysis result comprises an intermediate image, wherein the answer is based on the intermediate image.

Some examples of the method, apparatus, non-transitory computer readable medium, and system further include generating a subsequent action based on the vision analysis result. Some examples further include generating, using an additional vision expert model, an additional vision analysis result based on the subsequent action, wherein the answer is based on the additional vision analysis.

Some examples of the method, apparatus, non-transitory computer readable medium, and system further include obtaining an additional image, wherein the query is about the image and the additional image, and wherein the action is generated based on the image and the additional image. Some examples of the method, apparatus, non-transitory computer readable medium, and system further include selecting the vision expert model from a plurality of vision expert models based on the action.

A method for image perception is described. One or more aspects of the method include obtaining an image and a query about the image; generating, using an orchestrator vision-language model, an action based on the image and the query; generating, using a specialized vision-language model, an analysis result based the image and the action; and generating, using the orchestrator vision-language model, an answer to the query based on the analysis result.

Some examples of the method, apparatus, non-transitory computer readable medium, and system further include generating, using the specialized vision-language model, a prompt for a vision expert model. Some examples further include generating, using the vision expert model, a vision analysis result based the image and the prompt, wherein the analysis result is based on the vision analysis result. In some aspects, the vision analysis result comprises an intermediate image, wherein the answer is based on the intermediate image.

Some examples of the method, apparatus, non-transitory computer readable medium, and system further include generating a task requirement analysis comprising a plurality of actions including the action. Some examples of the method, apparatus, non-transitory computer readable medium, and system further include selecting the specialized vision-language model from a plurality of specialized vision-language models based on the action. Some examples of the method, apparatus, non-transitory computer readable medium, and system further include obtaining an additional image, wherein the query is about the image and the additional image, and wherein the action is generated based on the image and the additional image.

An apparatus for image perception is described. One or more aspects of the apparatus include a memory component; a processing device coupled to the memory component, the processing device configured to perform operations comprising: obtaining an image and a query about the image; generating, using an orchestrator vision-language model, an action based on the image and the query; generating, using a vision expert model, a vision analysis result based the image and the action; and generating, using the orchestrator vision-language model, an answer to the query based on the vision analysis result.

Some examples of the apparatus, system, and method further include generating, using a specialized vision-language model, a prompt for the vision expert model, wherein the vision analysis result is based on the prompt. Some examples of the apparatus, system, and method further include generating a task requirement analysis comprising a plurality of actions including the action. In some aspects, the vision analysis result comprises an intermediate image, wherein the answer is based on the intermediate image.

Some examples of the apparatus, system, and method further include generating a subsequent action based on the vision analysis result. Some examples further include generating, using an additional vision expert model, an additional vision analysis result based on the subsequent action, wherein the answer is based on the additional vision analysis. Some examples of the apparatus, system, and method further include obtaining an additional image, wherein the query is about the image and the additional image, and wherein the action is generated based on the image and the additional image. Some examples of the apparatus, system, and method further include selecting the vision expert model from a plurality of vision expert models based on the action.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image and a query about the image;
generating, using an orchestrator vision-language model, an action based on the image and the query;
generating, using a vision expert model, a vision analysis result based the image and the action; and
generating, using the orchestrator vision-language model, an answer to the query based on the vision analysis result.

2. The method of claim 1, further comprising:
generating, using a specialized vision-language model, a prompt for the vision expert model, wherein the vision analysis result is based on the prompt.

3. The method of claim 1, wherein generating the action comprises:
generating a task requirement analysis comprising a plurality of actions including the action.

4. The method of claim 1, wherein:
the vision analysis result comprises an intermediate image, wherein the answer is based on the intermediate image.

5. The method of claim 1, further comprising:
generating a subsequent action based on the vision analysis result; and
generating, using an additional vision expert model, an additional vision analysis result based on the subsequent action, wherein the answer is based on the additional vision analysis.

6. The method of claim 1, further comprising:
obtaining an additional image, wherein the query is about the image and the additional image, and wherein the action is generated based on the image and the additional image.

7. The method of claim 1, further comprising:
selecting the vision expert model from a plurality of vision expert models based on the action.

8. A non-transitory computer readable medium storing code for image processing, the code comprising instructions that, when executed by at least one processor, cause the at least one processor to perform operations comprising:
obtaining an image and a query about the image;
generating, using an orchestrator vision-language model, an action based on the image and the query;
generating, using a specialized vision-language model, an analysis result based the image and the action; and
generating, using the orchestrator vision-language model, an answer to the query based on the analysis result.

9. The non-transitory computer readable medium of claim 8, the code further comprising instructions that, when executed by the at least one processor, cause the at least one processor to perform operations comprising:
generating, using the specialized vision-language model, a prompt for a vision expert model; and
generating, using the vision expert model, a vision analysis result based the image and the prompt, wherein the analysis result is based on the vision analysis result.

10. The non-transitory computer readable medium of claim 9, wherein:
the vision analysis result comprises an intermediate image, wherein the answer is based on the intermediate image.

11. The non-transitory computer readable medium of claim 8, the code further comprising instructions that, when executed by the at least one processor, cause the at least one processor to perform operations comprising:
generating a task requirement analysis comprising a plurality of actions including the action.

12. The non-transitory computer readable medium of claim 8, the code further comprising instructions that, when executed by the at least one processor, cause the at least one processor to perform operations comprising:
selecting the specialized vision-language model from a plurality of specialized vision-language models based on the action.

13. The non-transitory computer readable medium of claim 8, the code further comprising instructions that, when executed by the at least one processor, cause the at least one processor to perform operations comprising:
obtaining an additional image, wherein the query is about the image and the additional image, and wherein the action is generated based on the image and the additional image.

14. A system for image processing, comprising:
a memory component;
a processing device coupled to the memory component, the processing device configured to perform operations comprising:
obtaining an image and a query about the image;
generating, using an orchestrator vision-language model, an action based on the image and the query;
generating, using a vision expert model, a vision analysis result based the image and the action; and
generating, using the orchestrator vision-language model, an answer to the query based on the vision analysis result.

15. The system of claim 14, the processing device being further configured to perform:
generating, using a specialized vision-language model, a prompt for the vision expert model, wherein the vision analysis result is based on the prompt.

16. The system of claim 14, wherein generating the action comprises:
generating a task requirement analysis comprising a plurality of actions including the action.

17. The system of claim 14, wherein:
the vision analysis result comprises an intermediate image, wherein the answer is based on the intermediate image.

18. The system of claim 14, the processing device being further configured to perform:
generating a subsequent action based on the vision analysis result; and
generating, using an additional vision expert model, an additional vision analysis result based on the subsequent action, wherein the answer is based on the additional vision analysis.

19. The system of claim 14, the processing device being further configured to perform:
obtaining an additional image, wherein the query is about the image and the additional image, and wherein the action is generated based on the image and the additional image.

20. The system of claim 14, the processing device being further configured to perform:
selecting the vision expert model from a plurality of vision expert models based on the action.
